(19) United States
(12) Patent Application Publication
(10) Pub. No.: US 2010/0153568 A1
(43) Pub. Date: Jun. 17, 2010

(54) METHODS, APPARATUSES, AND COMPUTER PROGRAM PRODUCTS FOR PROVIDING A LOCAL PROXY FOR ACCESSING WEB SERVICES

(75) Inventors: Juha Uola, Tampere (FI); Raine Makelainen, Tampere (FI); Yan Fu, Espoo (FI)

Correspondence Address: DITTHAVONG MORI & STEINER, P.C., 918 Prince Street, Alexandria, VA, 22314, US

(73) Assignee: Nokia Corporation

(21) Appl. No.: 12/336,000

(22) Filed: Dec. 16, 2008

(51) Int. Cl. G06F 15/173

(52) U.S. Cl. 709/229

(57) ABSTRACT

A method, apparatus, and computer program product are provided for providing a local proxy for accessing web services. An apparatus may include a processor configured to receive, at a proxy service implemented on the apparatus, a first HTTP request from a HTTP protocol client application executed on the apparatus. The first HTTP request may be directed to a first network location, wherein the HTTP client application is associated with the first network location. The processor may be further configured to determine whether the first HTTP request includes an indication of a second network location for circumventing a same-origin policy. The processor may additionally be configured to transmit a second HTTP request to the second network location when the first HTTP request includes an indication of a second network location. Corresponding methods and computer program products are also provided.

### TECHNOLOGICAL FIELD

Embodiments of the present invention relate generally to communication technology and, more particularly, relate to methods, apparatuses, and computer program products for providing a local proxy for accessing web services.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies as well as evolved computing devices making use of networking technologies continue to facilitate ease of information transfer and convenience to users. This explosive growth of mobile communications networks has followed the evolution of mobile devices, such as cellular phones, personal digital assistants (PDAs), and other portable electronic devices from luxury items to ubiquitous devices integrated into the everyday lives of individuals from all walks of life. Mobile electronic devices are now used extensively to browse websites and utilize web applications accessed over the Internet. In this regard, many mobile electronic devices now implement web browsers offering a range of services that at least closely approximate web browsers found on personal computing devices.

Many websites and web applications now feature rich content that may be obtained from multiple sources and combined to provide an integrated experience for users. Such websites and web applications are referred to as “mashup” applications. However, mashup applications may be impeded from obtaining content from multiple sources by same-origin policies enforced by web browsers. A same-origin policy is a security policy enforced by a web browser such that a web page or web application, such as a mashup application, that is associated with a first origin in that the mashup application is loaded from and/or is otherwise associated with the first origin cannot, for example, make hypertext transfer protocol (HTTP) requests requesting to load content from a second origin. In this regard, an origin is defined by a same-origin policy in terms of a domain name value and in some instances also in terms of a protocol value and port value. Two pages belong to the same-origin only if the values in which an origin is defined in terms of by the same-origin policy are the same.

Some techniques have been implemented in an attempt to circumvent the same-origin policy so as to allow mashup applications to function properly in web browsers enforcing a same-origin policy. However, current techniques are hindered by drawbacks. One such current technique is to route hypertext transfer protocol (HTTP) traffic through a remote proxy service such that from a web browser point of view all traffic is going to the same server so that same-origin policy is not violated. However, remote proxy services may pose drawbacks to users and developers of mashup applications. One drawback is that a mashup application using the proxy must know the proxy and be programmed to use the proxy in order to access web services from an origin other than the origin from which the mashup application was loaded. Thus, a remote proxy is not a generic solution that may work with any mashup application. A further drawback with respect to use of a remote proxy is that it may open a security breach, thus enabling access to any arbitrary web service through the remote proxy. Another drawback involves access of content provided by a local content server implemented on the same computing device as the web browser in which the mashup application is loaded. If content provided by this local content server has a different origin than the origin from which the mashup application was loaded, then the mashup application must route a request for content provided by the local content server through the remote proxy server. The remote proxy server will then forward the request to the local content server, receive a response from the local content server, and forward the response to the mashup application. This approach may result in a latency that may be noticeable to a user or otherwise negatively affect execution of the mashup application as use of the proxy server requires multiple requests and responses to be transmitted over a network even though the content is provided by a local content server embodied on the computing device on which the mashup application is executed. Further, use of a remote proxy server to circumvent the same-origin policy requires an active network connection so that the mashup application can send requests to the remote proxy server. This technique thus prevents the mashup application from accessing content provided by the local content server when a network connection is not available or if a network connection has been disabled, such as to conserve power consumption.

Accordingly, it would be advantageous to provide methods, apparatuses, and computer program products for providing a local proxy for accessing web services that may circumvent same-origin policy and address at least some of the deficiencies in prior art techniques.

### BRIEF SUMMARY OF SOME EXAMPLES OF THE INVENTION

A method, apparatus, and computer program product are therefore provided for providing a local proxy for accessing web services. In this regard, a method, apparatus, and computer program product may be provided that may provide several advantages to a user of a computing device. Embodiments of the invention provide a local proxy for accessing web services. In this regard, embodiments of the invention provide a local proxy to which HTTP requests from HTTP client applications, such as mashup applications, are routed so as to circumvent a same-origin policy that may, for example, be enforced by a web browser in which the HTTP client application is executed. Embodiments of the invention implementing a local proxy provide several advantages for developers and users of mashup applications over solutions using a remote proxy to circumvent a same-origin policy. In this regard, embodiments of the invention implementing a local proxy provide a way to circumvent same origin policy that is transparent to the mashup application and thus the mashup application can be developed and executed without defining any device or implementation specific configuration settings to enable the mashup application to use the local proxy. Further, embodiments of the invention allow a mashup application to access content, such as context information, provided by a local content server even when a communication link, such as the communication link 110 is unavailable or disabled such that access to a remote proxy is not available due to lack of a network connection.

In a first exemplary embodiment, a method is provided, which may include receiving, at a proxy service implemented on a computing device, a first HTTP request from a HTTP protocol client application executed on the computing device. The first HTTP request may be directed to a first network location, wherein the HTTP client application was associated with the first network location. The method may further include determining whether the first HTTP request includes an indication of a second network location for circumventing a same-origin policy. The method may additionally include transmitting a second HTTP request to the second network location when the first HTTP request includes an indication of a second network location. The method may also include transmitting a second HTTP request to the first network location when the first HTTP request does not include an indication of a second network location.

In another exemplary embodiment, a computer program product is provided. The computer program product includes at least one computer-readable storage medium having computer-readable program instructions stored therein. The computer-readable program instructions may include a plurality of program instructions. Although in this summary, the program instructions are ordered, it will be appreciated that this summary is provided merely for purposes of example and the ordering is merely to facilitate summarizing the computer program product. The example ordering in no way limits the implementation of the associated computer program instructions. The first program instruction is for receiving, at a proxy service implemented on a computing device, a first HTTP request from a HTTP protocol client application executed on the computing device. The first HTTP request may be directed to a first network location, wherein the HTTP client application was associated with the first network location. The second program instruction is for determining whether the first HTTP request includes an indication of a second network location for circumventing a same-origin policy. The third program instruction is for transmitting a second HTTP request to the second network location when the first HTTP request includes an indication of a second network location. The fourth program instruction is for transmitting a second HTTP request to the first network location when the first HTTP request does not include an indication of a second network location.

In another exemplary embodiment, an apparatus is provided, which may include a processor configured to receive, at a proxy service implemented by the apparatus, a first HTTP request from a HTTP protocol client application executed on the apparatus. The first HTTP request may be directed to a first network location, wherein the HTTP client application was associated with the first network location. The processor may be further configured to determine whether the first HTTP request includes an indication of a second network location for circumventing a same-origin policy. The processor may additionally be configured to transmit a second HTTP request to the second network location when the first HTTP request includes an indication of a second network location. The processor may also be configured to transmit a second HTTP request to the first network location when the first HTTP request does not include an indication of a second network location.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system for providing a local proxy for accessing web services according to an exemplary embodiment of the present invention;

FIG. 2 is a schematic block diagram of a mobile terminal according to an exemplary embodiment of the present invention; and

FIG. 3 is a flowchart according to an exemplary method for providing a local proxy for accessing web services according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, a “mashup application” refers to a website or web application that combines data from more than one source into a single integrated tool or experience. In this regard, a mashup application may combine web services accessed from multiple sources to create a new and distinct web service that was not originally provided by any of the sources accessed by the mashup application to obtain data.

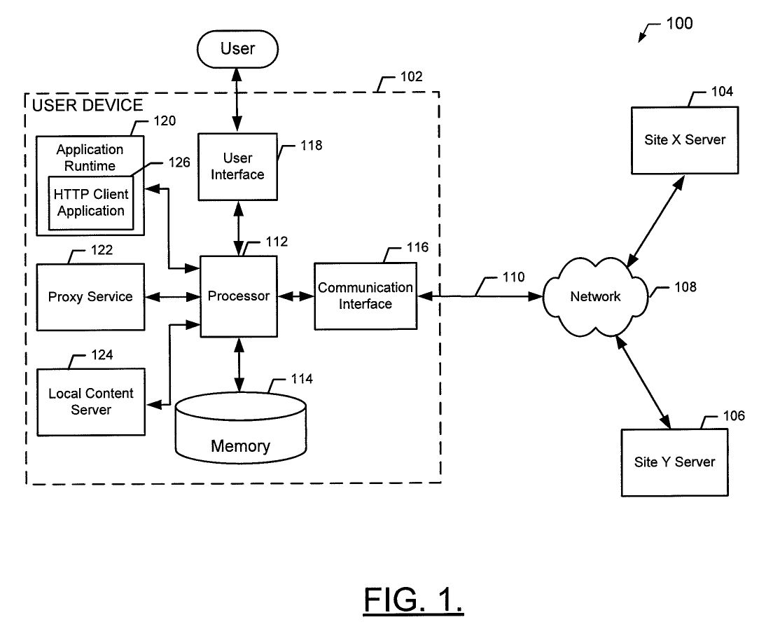

FIG. 1 illustrates a block diagram of a system 100 for providing a local proxy for accessing web services according to an exemplary embodiment of the present invention. As used herein, “exemplary” merely means an example and as such represents one example embodiment for the invention and should not be construed to narrow the scope or spirit of the invention in any way. It will be appreciated that the scope of the invention encompasses many potential embodiments in addition to those illustrated and described herein. As such, while FIG. 1 illustrates one example of a configuration of a system for providing a local proxy for accessing web services, numerous other configurations may also be used to implement embodiments of the present invention.

Referring now to FIG. 1, the system 100 includes a user device 102, and one or more remote servers providing web services configured to communicate over a network 108. In FIG. 1, two such remote servers (Site X Server 104 and Site Y Server 106) are illustrated. However, it will be appreciated that the system 100 may comprise only a single remote server or may comprise any number of additional remote servers. The network 108 may comprise a wireline network, wireless network, or some combination thereof, and in an exemplary embodiment may comprise or otherwise be embodied as the Internet. The user device 102 may be embodied as a server, desktop computer, laptop computer, mobile terminal, mobile computer, mobile phone, mobile communication device, game device, digital camera/camcorder, audio/video player, television device, radio receiver, digital video recorder, positioning device, any combination thereof, and/or the like. In some embodiments, the user device 102 is configured to access the network 108 over the communication link 110. In this regard, the communications link 110 may comprise a wired communications link, wireless communications link, or some combination thereof. Examples of wired communications link embodiments of the communications link 110 include, but are not limited to, a Universal Serial Bus (USB) cable, Firewire (Institute of Electrical and Electronics Engineers (IEEE) 1394) cable, parallel cable (IEEE 1284), serial cable (IEEE 1384), small computer system interface (SCSI), and/or the like. Examples of wireless communications link embodiments of the communications link 110 include, but are not limited to, a Bluetooth™ connection, wireless local area network (WLAN) connection, such as in accordance with one of the 802.11 standards, other radio frequency communications interface standards, infrared (IR), wireless USB, and/or the like.

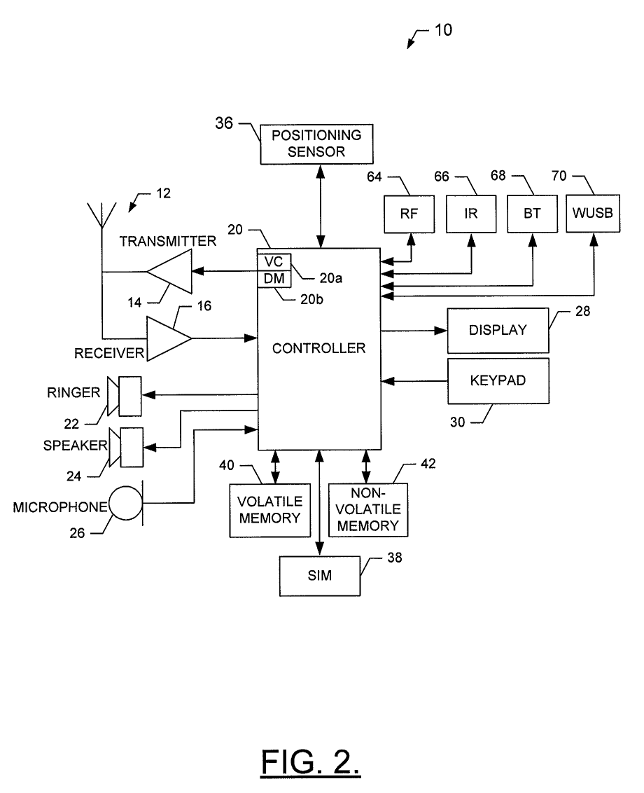

In an exemplary embodiment, the user device 102 is embodied as a mobile terminal, such as that illustrated in FIG. 2. In this regard, FIG. 2 illustrates a block diagram of a mobile terminal 10 representative of one embodiment of a user device 102 in accordance with embodiments of the present invention. It should be understood, however, that the mobile terminal illustrated and hereinafter described is merely illustrative of one type of user device 102 that may benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 10 may include an antenna 12 (or multiple antennas 12) in communication with a transmitter 14 and a receiver 16. The mobile terminal may also include a controller 20 or other processor(s) that provides signals to and receives signals from the transmitter and receiver, respectively. These signals may include signaling information in accordance with an air interface standard of an applicable cellular system, and/or any number of different wireless networking techniques, comprising but not limited to Wireless-Fidelity (Wi-Fi), wireless local access network (WLAN) techniques such as Institute of Electrical and Electronics Engineers (IEEE) 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) protocols.

It is understood that the controller 20 may comprise circuitry for implementing audio/video and logic functions of the mobile terminal 10. For example, the controller 20 may comprise a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the Internet or other networks.

The mobile terminal 10 may also comprise a user interface including, for example, an earphone or speaker 24, a ringer 22, a microphone 26, a display 28, a user input interface, and/or the like, which may be operationally coupled to the controller 20. As used herein, “operationally coupled” may include any number or combination of intervening elements (including no intervening elements) such that operationally coupled connections may be direct or indirect and in some instances may merely encompass a functional relationship between components. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), ajoystick (not shown), and/or other input device. In embodiments including a keypad, the keypad may comprise numeric (0-9) and related keys (#, *), and/or other keys for operating the mobile terminal.

The mobile terminal 10 may include a positioning sensor 36. The positioning sensor 36 may include, for example, a global positioning system (GPS) sensor, an assisted global positioning system (Assisted-GPS) sensor, etc. In one embodiment, however, the positioning sensor may include a pedometer or inertial sensor. Further, the positioning sensor may determine the location of the mobile terminal based upon signal triangulation or other mechanisms. The positioning sensor may be configured to determine a location of the mobile terminal, such as latitude and longitude coordinates of the mobile terminal or a position relative to a reference point such as a destination or a start point. Information from the positioning sensor may be communicated to a memory of the mobile terminal or to another memory device to be stored as a position history or location information. Furthermore, a memory of the mobile terminal may store instructions for determining cell id information. In this regard, the memory may store an application program for execution by the controller 20, which may determine an identity of the current cell, i.e., cell id identity or cell id information, with which the mobile terminal is in communication. In conjunction with the positioning sensor, the cell id information may be configured to more accurately determine a location of the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, the user device 102 is not limited to being embodied as a mobile terminal 10 and as previously described, may be embodied as any computing device, mobile or fixed. Each remote server (e.g., the Site X Server 104 and Site Y Server 106) may be embodied as any computing device or plurality of computing devices configured to provide web services and/or websites to a user device 102 over the network 108. Although only a single user device 102 is illustrated in FIG. 1, the system 100 may comprise a plurality of user devices 102.

In an exemplary embodiment, the user device 102 includes various means, such as a processor 112, memory 114, communication interface 116, user interface 118, and proxy service 122 for performing the various functions herein described. In some embodiments, the client device may additionally include means, such as an application runtime 120 and/or a local content server 124. These means of the user device 102 as described herein may be embodied as, for example, hardware elements (e.g., a suitably programmed processor, combinational logic circuit, and/or the like), computer code (e.g., software or firmware) embodied on a computer-readable medium (e.g. memory 114) that is executable by a suitably configured processing device (e.g., the processor 112), or some combination thereof. The processor 112 may, for example, be embodied as various means including a microprocessor, a coprocessor, a controller, or various other processing elements including integrated circuits such as, for example, an ASIC (application specific integrated circuit) or FPGA (field programmable gate array). In embodiments wherein the user device 102 is embodied as a mobile terminal 10, the processor 112 may be embodied as or otherwise comprise the controller 20. In an exemplary embodiment, the processor 112 is configured to execute instructions stored in the memory 114 or otherwise accessible to the processor 112. Although illustrated in FIG. 1 as a single processor, in some embodiments the processor 112 comprises a plurality of processors. The plurality of processors may accordingly operate cooperatively to implement the functionality of the processor 112 as described herein.

The memory 114 may include, for example, volatile and/or non-volatile memory. In an exemplary embodiment, the memory 114 is configured to store information, data, applications, instructions, or the like for enabling the user device 102 to carry out various functions in accordance with exemplary embodiments of the present invention. For example, the memory 114 may be configured to buffer input data for processing by the processor 112. Additionally or alternatively, the memory 114 may be configured to store instructions for execution by the processor 112. The memory 114 may comprise one or more databases that store information in the form of static and/or dynamic information. In this regard, the memory 114 may store, for example, access rules, security permissions, and/or the like defining access rules for web services requesting data from a particular network location. This stored information may be stored and/or used by the proxy service 122 during the course of performing its functionalities.

The communication interface 116 may be embodied as any device or means embodied in hardware, software, firmware, or a combination thereof that is configured to receive and/or transmit data from/to a remote device, such as the Site X Server 104 and/or Site Y Server 106 over the network 108. In one embodiment, the communication interface 116 is at least partially embodied as or otherwise controlled by the processor 112. The communication interface 116 may include, for example, an antenna, a transmitter, a receiver, a transceiver and/or supporting hardware or software for enabling communications with other entities of the system 100. The communication interface 116 may be configured to receive and/or transmit data using any protocol that may be used for communications between computing devices of the system 100. In this regard, the communication interface 116 may be configured to access the network 108 via the communication link 110. The communication interface 116 may additionally be in communication with the memory 114, user interface 118, application runtime 120, proxy service 122, local content server 124, and/or HTTP client application 126, such as via a bus.

In at least some embodiments, the user interface 118 is in communication with the processor 112 to receive an indication of a user input and/or to provide an audible, visual, mechanical, or other output to the user. As such, the user interface 118 may include, for example, a keyboard, a mouse, a joystick, a display, a touch screen display, a microphone, a speaker, and/or other input/output mechanisms. The user interface 118 may be configured to provide means for requesting and receiving a selection of a security permission option from a user of the user device 102. The user interface 118 may be in communication with the memory 114, communication interface 116, application runtime 120, proxy service 122, local content server 124, and/or HTTP client application 126, such as via a bus.

The application runtime 120 may be embodied as various means, such as hardware, software, firmware, or some combination thereof and, in one embodiment, may be embodied as or otherwise controlled by the processor 112. In embodiments where the application runtime 120 is embodied separately from the processor 112, the application runtime 120 may be in communication with the processor 112. The application runtime 120 is configured to provide a runtime environment for an HTTP client application 126. The application runtime 120 is embodied as a web browser in at least one embodiment of the present invention. In other embodiments, the application runtime 120 may be embodied as a Flash runtime engine, Java runtime engine (executing an applet(s), for example), Silverlight runtime engine, and/or any other means for providing a runtime environment to facilitate execution of an HTTP client application 126.

The HTTP client application 126 may comprise a mashup application or other web application. The HTTP client application 126 may be implemented in any suitable programming language (e.g., C/C++, Java, JavaScript, asynchronous Java Script and XML (AJAX), HTML, ActionScript, Python, and/or the like) and may run in any supported runtime implementation of the application runtime 120. In this regard, the application runtime 120 is configured to load and execute an HTTP client application 126 received from any server or other network location accessible to the application runtime 120. Accordingly, the application runtime 120 may load an HTTP client application 126 received from, for example, the Site X Server 104, Site Y Server 106, and/or the local content server 124. Although, HTTP is used herein for purposes of an example communications protocol for transmitting and receiving data over the network 108, it will be appreciated that other appropriate communications and/or transfer protocols may be substituted for HTTP and accordingly, the HTTP client application 126 may be configured to send and receive data in accordance with other communications protocols. In other embodiments, for example, transmission control protocol (TCP) is substituted where HTTP is used herein and the HTTP client application 126 is embodied as a TCP client application configured to send and receive data in accordance with TCP.

The proxy service 122 may be embodied as various means, such as hardware, software, firmware, or some combination thereof and, in one embodiment, is embodied as or otherwise controlled by the processor 112. In embodiments wherein the proxy service 122 is embodied separately from the processor 112, the proxy service 122 may be in communication with the processor 112. The proxy service 122 is configured to intercept or otherwise receive HTTP requests for data originating from the application runtime 120 and/or an HTTP client application 126 loaded by the application runtime 120 and transmit a corresponding HTTP request to an appropriate server, such as the Site X Server 104, Site Y Server 106, and/or the local content server 124, based at least in part upon information included in the HTTP request. The proxy service 122 may be additionally configured to intercept or otherwise receive an HTTP response to a HTTP request and send a corresponding HTTP response to the application runtime 120 and/or HTTP client application 126. In this regard, the proxy service 122 may, as will be described further herein, provide a means for circumventing a same-origin policy that may be enforced by the application runtime 120. In at least some embodiments, the proxy service 122 is further configured to enforce security access policies based at least in part upon a set of access rules stored in a local memory, such as the memory 114.

The local content server 124 may be embodied as various means, such as hardware, software, firmware, or some combination thereof and, in one embodiment, is embodied as or otherwise controlled by the processor 112. In embodiments wherein the local content server 124 is embodied separately from the processor 112, the local content server 124 may be in communication with the processor 112. The local content server 124 is configured to provide data to web services, applications, mashup applications, and/or the like that may be executed on the client device 102 (e.g., an HTTP client application 126) or on a remote computing device, such as the Site X Server 104 or the Site Y Server 106. In some embodiments, the data provided by the local content server 124 includes context information relating to the client device 102 and/or a user of the client device 102. Further, in at least some embodiments, the data provided by the local content server 124 includes any other data located on the user device 102, such as, for example, data from a calendar application embodied on the user device 102, files stored, such as in memory 114, and/or the like. The local content server 124 may be configured to obtain this context information from a variety of sources and may be configured to aggregate the obtained context information. For example, in some embodiments wherein the client device 102 is embodied as a mobile terminal 10, the local content server 124 is configured to obtain context information indicating a location of the client device 102 from the positioning sensor 36. In another example, the local content server 124 is configured to interface with one or more applications, such as, for example, a calendar application embodied on the client device 102.

Returning to the proxy service 122, in at least some embodiments, the proxy service 122 is configured to receive a first HTTP request from the HTTP client application 126 that is directed to a first network location. The HTTP request may, for example, comprise an extensible markup language (XML) HTTP Request, also referred to as an “XHR”. As used herein, “network location” includes a domain name, portion of a domain name, internet protocol (IP) address, host name, port, protocol, and/or the like identifying a network location on the system 100 to which data is sent and/or from which data is received. A network location may identify, for example, a network location of the Site X Server 104, Site Y Server 106, and/or the local content server 124. In an exemplary embodiment, the first network location is the network location from which the HTTP client application 126 was loaded so as to circumvent a same-origin policy enforced by the application runtime 120 when necessary. In this regard, the HTTP client application 126 and/or the application runtime 120 may be configured to send all outgoing HTTP requests to the proxy service 122 and may use the network location of the server from which the HTTP client application 126 was loaded as the destination network location in the HTTP request regardless of the intended destination network location of the HTTP request. Additionally or alternatively, the client device 120 may further comprise a convenience library that may be embodied in software and executed by the processor 112 in the context of the application runtime 120 as an intermediary between the HTTP client application 126 and the proxy service 122. The convenience library may be configured to send all outgoing HTTP requests originating from the HTTP client application 126 to the proxy service 122 and may use the network location of the server from which the HTTP client application 126 was loaded as the destination location in the HTTP request regardless of the intended destination network location of the HTTP request. Accordingly, embodiments including a convenience library may provide a degree of transparency between the proxy service 122 and the application runtime 120 or HTTP client application 126 such that no special configuration changes or rules are necessary to enable the application runtime 120 or HTTP client application 126 to utilize the proxy service 122.

In at least some embodiments, the proxy service 122 is configured to determine for each received HTTP request, whether the HTTP request includes an indication of a second network location for circumventing a same-origin policy, such as may be enforced by the application runtime 120. The indication of a second network location may comprise an HTTP header including an indication of a second network location. However, an HTTP header is one example of an indication of a second network location for circumventing a same-origin policy. Additionally or alternatively, such an indication may comprise a TCP header and/or the like (e.g., when a protocol other than HTTP is used), an indication included in a URL included in the received HTTP request (e.g., http://www.SiteX.com/x-final-target/www.SiteY.com/photos/photo1.gif), and/or the like. Accordingly, HTTP header as used herein, is merely for purposes of example of one embodiment of the invention and other embodiments of the invention may convey an indication within an HTTP request using other means. The indication may have been added to the HTTP request by the HTTP client application 126, application runtime 120, or the convenience library. Accordingly, an exemplary embodiment of the proxy service 122 is configured to recognize and parse an HTTP header including an indication of a network location. Such an HTTP header may be an existing HTTP header capable of conveying an indication of a network location or may be a newly defined special-purpose HTTP header recognized by the proxy service 122. For example, the HTTP header may be defined as “x-final-target.” Thus, if an HTTP request includes an indication of a network location for Site Y Server 106 (“SiteY”), the HTTP request may include “x-final-target: SiteY.”

If a received HTTP request does not include an indication of a second network location, the proxy service 122 is configured to transmit a second HTTP request comprising the received HTTP request to the first network location. If, however, the received HTTP request does include an indication of a second network location, the proxy service 122 is configured in at least some embodiments to generate a second HTTP request including the content of the received HTTP request with the second network location in place of the first network location in the request and transmit the second HTTP request to the second network location. In one example embodiment, the proxy service 122 may generate a second HTTP request by substituting the indicated second network location for the first network location. If the second network location was indicated in the received HTTP request with an HTTP header, the HTTP header may be removed from the second HTTP request. For example, the HTTP client application 126 may have been or may be otherwise associated with the network location of Site X Server 104 (“SiteX”) and need to request data from Site Y Server 106. Thus the received HTTP request may comprise “http://www.SiteX.com/photos/photo1.gif x-final-target: SiteY.” The proxy service 122 may then generate a second HTTP request comprising “http://SiteY.com/photos/photo1.gif” and transmit the second HTTP request to Site Y Server 106. Similarly, for example, the HTTP client application 126 may need to request data from the local content server 124, which may have the network location “localHost.” Thus the received HTTP request may comprise “http://www.SiteX.com/locationInfo x-final-target: localHost.” The proxy service 122 may then generate a second HTTP request comprising “http://localHost/locationInfo” and transmit the second HTTP request to the local content server 124. Accordingly, the proxy service 122 in at least some embodiments of the invention enables the HTTP client application 126 to circumvent a same-origin policy and transmit an HTTP request to a network location (e.g., SiteY or localHost) other than the network location (e.g., SiteX) from which the HTTP client application was loaded by the application runtime 120.

In some embodiments, the proxy service 122 is further configured to intercept or otherwise receive an incoming first HTTP response received in response to a transmitted second HTTP request. The proxy service 122 is configured to then generate a second HTTP response. The proxy service 122 may be configured to generate the second HTTP response based at least in part upon the first HTTP request and the first HTTP response. In this regard, the proxy service 122 may generate a second HTTP response including the content of the first HTTP response, but the network location of the first HTTP request. For example, assume the first HTTP request comprised “http://www.SiteX.com/photos/photo1.gif x-final-target: SiteY” and the proxy service 122 generated a second HTTP request comprising “http://SiteY.com/photos/photo1.gif” and transmitted the second HTTP request to Site Y Server 106 as described above to circumvent a same-origin policy. Accordingly, the received first HTTP response would include SiteY as the network location from which the first HTTP response originated. In order to conform with the same-origin policy, the proxy service 122 may be configured to replace the network location of the first HTTP response (e.g., SiteY) with the first network location of the first HTTP request (e.g., Site X) to generate a second HTTP response complying with the same-origin policy. The proxy service 122 may include in the second HTTP response an indication of the network location from which the first HTTP response was received, such as through use of an HTTP header. The proxy service 122 may then transmit the second HTTP response to the HTTP client application 126 as a response to the first HTTP request.

In at least some embodiments, the proxy service 122 is configured to enforce security access policies based at least in part upon a set of access rules stored in a local memory, such as the memory 114. In this regard, the proxy service 122 may be configured to store and access a set of access rules, which may, for example, be stored in a relational database. Each access rule may define a network location representing the origin of an HTTP client application 126 making an HTTP request (e.g., the first network location to which a received HTTP request is directed), a network location of a web service or computing device from which the HTTP client application 126 is requesting data (e.g., a second network location indicated in the received HTTP request), and an access permission for such an HTTP request. The access permission may define an unconditional permission (e.g., always allowed or never allowed) or may define a conditional permission (e.g., allowed under a defined condition(s), which may include, for example, a time period of the request, a type of data requested, size of data requested, and/or the like). For example, an access rule may resemble the following:

| From | To | Permission |
|---|---|---|
| SiteX | localHost | always_allow |

Accordingly, the proxy service 122 may be configured to determine, when a received HTTP request includes an indication of a second network location, whether a stored access rule governs the received HTTP request. For example, assume the proxy service 122 receives an HTTP request from the HTTP client application 126 comprising “http://www.SiteX.com/locationInfo x-final-target: localHost”. The first network location in this request is SiteX. The second network location indicated in the request is localHost. Accordingly, the proxy service 122 may, for example, search the set of access rules stored in memory 114 for any access rules including or covering SiteX in the “From” field. The proxy service 122 may then, for example, search the access rules including SiteX in the “From” field for any that include or cover “localhost” in the “To” field. Accordingly, the above example access rule satisfies these search criteria and thus governs the received HTTP request. It will be appreciated, however, that the “From” and “To” fields of access rules satisfying the search criteria may not necessarily explicitly include “SiteX” and/or “localHost” as the example access rule illustrated above does, but may instead include a wildcard network location or other network location that may cover a plurality of network locations in addition to SiteX and/or localHost. Further, the above example access rule is merely an example implementation of an access rule and accordingly other embodiments may not include “From,” “To,” and/or “Permission” fields or the fields may be labeled with different names. Accordingly, these example search criteria and scenarios are provided merely as an example of one embodiment of the invention.

The proxy service 122 may be further configured to parse the “Permission” field of an access rule governing the received HTTP request to determine whether the HTTP client application 126 is allowed to transmit an HTTP request to the second domain, and if so, under what circumstances. In the example access rule governing the received HTTP request, the “Permission” field indicates that such requests are always allowed. Therefore, the proxy service 122 may be configured to transmit a second HTTP request to localHost since the access rule allows such HTTP requests. If, however, the access rule denied such HTTP requests, the proxy server 122 may be configured to not transmit a second HTTP request to localHost and may be further configured to send an error message to the HTTP Client Application 126 stating that the request was blocked due to a security policy.

If no stored access rule governs an HTTP request received from the HTTP client application 126, the proxy service 122 may be configured to prompt a user of the user device 102 to select a security permission option for the HTTP request from a plurality of selectable security permission options. For example, the proxy service 122 may be configured to cause the following prompt to be displayed to the user on a display of the user interface 118:
Web application loaded from www.siteX.com is requesting access to localHost.
Option 1: Deny once
Option 2: Allow once
Option 3: Always deny
Option 4: Always allow

The proxy service 122 may then receive an indication of a user-selected security permission option for the received HTTP request selected by a user using an input means of the user interface 118. The proxy service 122 may be configured to then determine whether the selected security permission option allows the received HTTP request. When the selected security permission option allows the received HTTP request, the proxy service may generate a second HTTP request as previously described wherein the first network location (e.g., SiteX) is replaced with the indicated second network location (e.g., localHost) and transmit the second HTTP request to the second network location. If, however, the user-selected security permission option denies the received HTTP request, the proxy service 122 will not transmit a second HTTP request to the second network location and may instead transmit an error message to the HTTP client application 126.

In some embodiments, if the user-selected security permission option comprises a rule applicable to more than just the single request, the proxy service 122 is further configured to generate an access rule based at least in part upon the selected security permission option. The proxy service 122 is additionally configured to update the set of access rules stored in memory 114 to include the generated access rule.

It will be appreciated that access rules applied by the proxy service 122 may be provided by entities or parties other than users of the user device 102. For example, network operators, organizations, a manufacturer of the user device 102, and/or the like having appropriate credentials or permission to modify the access rules may add an access rule to be applied by the proxy service 122.

In at least some embodiments, the proxy service 122 further comprises a cookie handler. In this regard, a server, such as the Site X Server 104, Site Y Server 106, or local content server 124 may include a cookie in a HTTP response. The cookie may provide a means to implement, for example, session management in web services. The application runtime 120 and/or HTTP client application 126 may include the cookie in future HTTP requests to the server. Accordingly, in embodiments including a cookie handler, the proxy service 122 is configured to determine whether an HTTP response resulting from an HTTP request including an indication of a second network location (e.g., an HTTP request including an “x-final-target” header) includes a cookie. If such an HTTP response includes a cookie, the proxy service 122 may be configured to remove the cookie from the response and store the cookie locally, such as in memory 114, and bind the cookie to the server defined in “x-final-target” header since the cookie is not intended to be bound to the network location that will be identified in the HTTP response that the proxy service 122 sends to the HTTP client application 126 as the source of the HTTP response. Similarly, when the proxy service 122 determines that an HTTP request received from the HTTP client application 126 and including an indication of a second network location, such as in an HTTP header, includes a cookie, the proxy service 122 may be configured remove the cookie (as it is intended to be included with an HTTP request sent to the network location to which the HTTP request is directed) and replace the cookie with a stored cookie bound to the indicated second network location (if there is a cookie bound to the second network location). Thus, such a cookie handler may effectively replace a cookie handling mechanism in the application runtime 120 for selected messages.

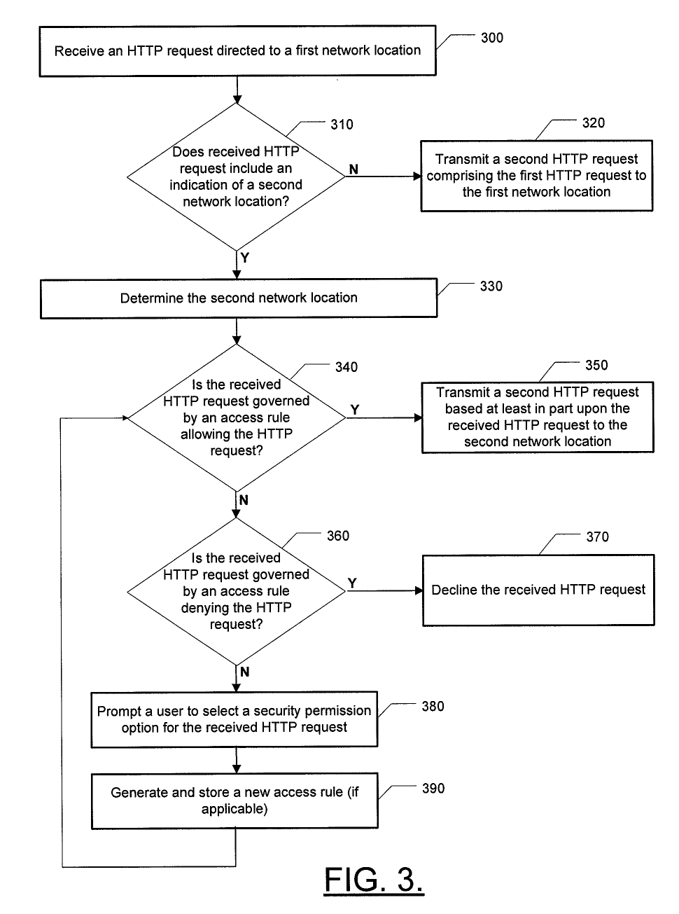

FIG. 3 is a flowchart of systems, methods, and computer program products according to exemplary embodiments of the invention. It will be understood that each block or step of the flowchart, and combinations of blocks in the flowchart, may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal, server, or other computing device and executed by a processor in the computing device. In some embodiments, the computer program instructions which embody the procedures described above may be stored by memory devices of a plurality of computing devices. As will be appreciated, any such computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, may be implemented by special purpose hardware-based computer systems which perform the specified functions or steps, or combinations of special purpose hardware and computer instructions.

In this regard, one exemplary method for providing a local proxy for accessing web services according to an exemplary embodiment of the present invention is illustrated in FIG. 3. The method may include the proxy service 122 receiving an HTTP request directed to a first network location from an HTTP client application 126 or an application runtime 120 executing an HTTP client application 126 that generated the HTTP request, at operation 300. The received HTTP request may be directed to a first network location, wherein the HTTP client application 126 is associated with the first network location in that the HTTP client application was loaded from and/or is otherwise associated with the first network location. Operation 310 may comprise the proxy service 122 determining whether the received HTTP request includes an indication of a second network location so as to circumvent a same-origin policy. The indication of a second network location may be included, for example, in an HTTP header or a URL included in the received HTTP request. If, at operation 310, the proxy service 122 determines that the received HTTP request does not include an indication of a second network location, the proxy service 122 may transmit a second HTTP request comprising the first HTTP request to the first network location, at operation 320.

On the other hand, if at operation 310, the proxy service 122 determines that the received HTTP request does include an indication of a second network location, the proxy service 122 may determine the second network location, at operation 330. In this regard, the proxy service 122 may, for example, parse an HTTP header included in the HTTP request to extract or otherwise determine the second network location. Operation 340 may then comprise the proxy service 122 determining whether the received HTTP request is governed by a stored access rule allowing the HTTP request. If, at operation 340, the proxy service 122 determines that the received HTTP request is governed by a stored access rule allowing the HTTP request, the proxy service 122 may transmit a second HTTP request based at least in part upon the received HTTP request to the second network location, at operation 350. In this regard, the proxy service 122 may generate and transmit a second HTTP request comprising the content of the received HTTP request, but directed to the second network location instead of the first network location.

If, on the other hand, the proxy service 122 determines at operation 340 that the received HTTP request is not governed by a stored access rule allowing the HTTP request, the proxy service 122 may determine whether the received HTTP request is governed by a stored access rule denying the HTTP request, at operation 360. If, at operation 360, the proxy service 122 determines that the HTTP request is governed by a stored access rule denying the received HTTP request, the proxy service 122 may decline the received HTTP request, at operation 370. Alternatively, if, at operation 360, the proxy service 122 determines that the HTTP request is not governed by a stored access rule denying the received HTTP request, the proxy service 122 may prompt a user over the user interface 118 to select a security permission option for the received HTTP request, at operation 380. Operation 390 may comprise the proxy service 122 generating and a new access rule and updating the set of stored access rules to include the new access rule if applicable. In this regard, if the selected security permission option applies to more than the current received request, the proxy service 122 may execute operation 390. The proxy server 122 may then proceed to operation 340 from where the proxy server 122 may handle the received HTTP request based at least in part upon the user-selected security permission option.

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, at least some embodiments of the invention provide several advantages to a user of a computing device, such as a mobile terminal 10. Embodiments of the invention provide a local proxy for accessing web services. In this regard, embodiments of the invention provide a local proxy to which HTTP requests from HTTP client applications, such as mashup applications, are routed so as to circumvent a same-origin policy that may, for example, be enforced by a web browser in which the HTTP client application is executed. Embodiments of the invention implementing a local proxy provide several advantages for developers and users of mashup applications over solutions using a remote proxy to circumvent a same-origin policy. In this regard, embodiments of the invention implementing a local proxy provide a circumvention to same origin policy that is transparent to the mashup application and thus the mashup application can be developed and executed without defining any device or implementation specific configuration settings to enable the mashup application to use the local proxy. Further, embodiments of the invention allow a mashup application to access content, such as context information, provided by a local content server even when a communication link, such as the communication link 110 is unavailable or disabled such that access to a remote proxy is not available due to lack of a network connection.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising a processor configured to:
receive, at a proxy service implemented by the apparatus, a first transfer protocol request from a transfer protocol client application executed on the apparatus, wherein the first transfer protocol request is directed to a first network location, and wherein the transfer protocol client application is associated with the first network location;
determine whether the first transfer protocol request includes an indication of a second network location for circumventing a same-origin policy; and
transmit a second transfer protocol request to the second network location when the first transfer protocol request includes an indication of a second network location.

2. An apparatus according to claim 1, wherein the processor is further configured to:
receive a first transfer protocol response to the second transfer protocol request;
generate a second transfer protocol response based at least in part upon the first transfer protocol request and the first transfer protocol response; and
transmit, to the transfer protocol client application, the second transfer protocol response in response to the first transfer protocol request.

3. An apparatus according to claim 1, wherein the processor is configured to determine whether the first transfer protocol request includes an indication of a second network location by determining whether the first transfer protocol request includes a transfer protocol header including an indication of a second network location.

4. An apparatus according to claim 1, wherein the transfer protocol client application comprises a mashup application.

5. An apparatus according to claim 4, wherein the mashup application is executed within an application runtime that enforces same-origin policy.

6. An apparatus according to claim 1, wherein the second network location is associated with a local content server embodied on the apparatus; and
wherein the processor is configured to transmit a second transfer protocol request to the second network location by transmitting a second transfer protocol request to the local content server.

7. An apparatus according to claim 6, wherein the local content server provides context information related to one or more of the apparatus or a user of the apparatus.

8. An apparatus according to claim 1, wherein the processor is further configured to:
determine, when the first transfer protocol request includes an indication of a second network location, based at least in part upon a set of access rules stored in a local memory whether a stored access rule governs the first transfer protocol request; and
determine, when a stored access rule governs the first transfer protocol request, whether the stored access rule allows a transfer protocol client application associated with the first network location to transmit transfer protocol requests to the second network location; and
wherein the processor is configured to transmit a second transfer protocol request to the second network location by transmitting a second transfer protocol request to the second network location when a stored access rule governs the first transfer protocol request and allows a transfer protocol client application associated with the first network location to transmit transfer protocol requests to the second network location.

9. An apparatus according to claim 8, wherein no stored access rule governs the first transfer protocol request; and wherein the processor is further configured to:
prompt a user of the apparatus to select a security permission option for the first transfer protocol request from a plurality of selectable security permission options;
receive an indication of a selected security permission option for the first transfer protocol request; and
determine whether the selected security permission option allows the transfer protocol client application to transmit a transfer protocol to the second network location; and
wherein the processor is configured to transmit a second transfer protocol request to the second network location by transmitting a second transfer protocol request to the second network location when the selected security permission option allows the transfer protocol client application to transmit a transfer protocol request to the second network location

10. An apparatus according to claim 9, wherein the processor is configured to:
generate an access rule based at least in part upon the selected security permission option; and
update the set of access rules to include the generated access rule.

11. A method comprising:
receiving, at a proxy service implemented on a computing device, a first transfer protocol request from a transfer protocol client application executed on the computing device, wherein the first transfer protocol request is directed to a first network location, and wherein the transfer protocol client application is associated with the first network location;
determining whether the first transfer protocol request includes an indication of a second network location for circumventing a same-origin policy; and
transmitting a second transfer protocol request to the second network location when the first transfer protocol request includes an indication of a second network location.

12. A method according to claim 11, further comprising:
receiving a first transfer protocol response to the second transfer protocol request;
generating a second transfer protocol response based at least in part upon the first transfer protocol request and the first transfer protocol response; and
transmitting, to the transfer protocol client application, the second transfer protocol response in response to the first transfer protocol request.

13. A method according to claim 11, wherein determining whether the first transfer protocol request includes an indication of a second network location comprises determining whether the first transfer protocol request includes a transfer protocol header including an indication of a second network location.

14. A method according to claim 11, further comprising:
determining, when the first transfer protocol request includes an indication of a second network location, based at least in part upon a set of access rules stored in a local memory whether a stored access rule governs the first transfer protocol request; and
determining, when a stored access rule governs the first transfer protocol request, whether the stored access rule allows a transfer protocol client application associated with the first network location to transmit transfer protocol requests to the second network location; and
wherein transmitting a second transfer protocol request to the second network location comprises transmitting a second transfer protocol request to the second network location when a stored access rule governs the first transfer protocol request and allows a transfer protocol client application associated with the first network location to transmit transfer protocol requests to the second network location.

15. A method according to claim 14, wherein no stored access rule governs the first transfer protocol request; and further comprising:
prompting a user of the computing device to select a security permission option for the first transfer protocol request from a plurality of selectable security permission options;
receiving an indication of a selected security permission option for the first transfer protocol request;
determining whether the selected security permission option allows the transfer protocol client application to transmit a transfer protocol to the second network location;
generating an access rule based at least in part upon the selected security permission option; and
updating the set of access rules to include the generated access rule and
wherein transmitting a second transfer protocol request to the second network location comprises transmitting a second transfer protocol request to the second network location when the selected security permission option allows the transfer protocol client application to transmit a transfer protocol request to the second network location.

16. A computer program product comprising at least one computer-readable storage medium having computer-readable program instructions stored therein, the computer-readable program instructions comprising:
a program instruction for receiving, at a proxy service implemented on a computing device, a first transfer protocol request from a transfer protocol client application executed on the computing device, wherein the first transfer protocol request is directed to a first network location, and wherein the transfer protocol client application was associated with the first network location;
a program instruction for determining whether the first transfer protocol request includes an indication of a second network location for circumventing a same-origin policy; and
a program instruction for transmitting a second transfer protocol request to the second network location when the first transfer protocol request includes an indication of a second network location.

17. A computer program product according to claim 16, further comprising:
a program instruction for receiving a first transfer protocol response to the second transfer protocol request;
a program instruction for generating a second transfer protocol response based at least in part upon the first transfer protocol request and the first transfer protocol response; and
a program instruction for transmitting, to the transfer protocol client application, the second transfer protocol response in response to the first transfer protocol request.

18. A computer program product according to claim 16, wherein the program instruction for determining whether the first transfer protocol request includes an indication of a second network location comprises instructions for determining whether the first transfer protocol request includes a transfer protocol header including an indication of a second network location.

19. A computer program product according to claim 16, further comprising:
a program instruction for determining, when the first transfer protocol request includes an indication of a second network location, based at least in part upon a set of access rules stored in a local memory whether a stored access rule governs the first transfer protocol request; and
a program instruction for determining, when a stored access rule governs the first transfer protocol request, whether the stored access rule allows a transfer protocol client application associated with the first network location to transmit transfer protocol requests to the second network location; and
wherein the program instruction for transmitting a second transfer protocol request to the second network location comprises instructions for transmitting a second transfer protocol request to the second network location when a stored access rule governs the first transfer protocol request and allows a transfer protocol client application associated with the first network location to transmit transfer protocol requests to the second network location.

20. A computer program product according to claim 19, wherein no stored access rule governs the first transfer protocol request; and further comprising:
a program instruction for prompting a user of the computing device to select a security permission option for the first transfer protocol request from a plurality of selectable security permission options;
a program instruction for receiving an indication of a selected security permission option for the first transfer protocol request;
a program instruction for determining whether the selected security permission option allows the transfer protocol client application to transmit a transfer protocol to the second network location;
a program instruction for generating an access rule based at least in part upon the selected security permission option; and
a program instruction for updating the set of access rules to include the generated access rule; and
wherein the program instruction for transmitting a second transfer protocol request to the second network location comprises instructions for transmitting a second transfer protocol request to the second network location when the selected security permission option allows the transfer protocol client application to transmit a transfer protocol request to the second network location.
